(19) United States
(12) Patent Application Publication
(10) Pub. No.: US 2009/0248358 A1
(43) Pub. Date: Oct. 1, 2009

(54) Real Time Operation Specification Calculation System That Provides Specifications To A User Interface

(76) Inventor: Peyman Safa, Hopatcong, NJ (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/060,443

(22) Filed: Apr. 1, 2008

(51) Int. Cl. G06F 15/00

(52) U.S. Cl. 702/182

(57) ABSTRACT

A system comprises a functional apparatus having a plurality of performance capabilities as per a specification, a user output interface, a processor for calculating the specification for achieving a desired performance of the functional apparatus; and an output controller for providing the calculated specification on the user output interface.

### BACKGROUND OF THE INVENTION

Various types of instruments, such as electronic test and measurement instruments, operate based on performance specifications. A user who has a known set of objectives in mind may select an instrument from a line of instruments having different specifications, based on which specifications meet the user's needs best and most cost-effectively. Generally, data sheets or manuals are provided to the user along with the instrument itself, so that the user can refer to the specifications in the data sheets as an aid for selecting the instrument from the line of instruments. The specifications play a significant role in influencing whether and how well the instrument meets the user's needs; for instance influencing the accuracy of the instrument.

For instruments that provide powerful or complex functionality, with high precision, their data sheets and specifications tend to be complicated and challenging to comprehend by the average user. Sometimes many such specifications influence the accuracy and performance of an instrument, and interpreting the specifications can become a daunting task for the user.

### SUMMARY OF THE INVENTION

A system comprises a functional apparatus having a plurality of performance capabilities as per a specification, a user output interface a processor for calculating the specification for achieving a desired performance of the functional apparatus; and an output controller for providing the calculated specification on the user output interface.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a schematic diagram of a functional apparatus embodying the invention.

FIG. 2 is a schematic diagram of a user interface of the functional apparatus of FIG. 1.

FIG. 3 is a flowchart showing operation of a system embodying the invention

FIG. 4 is a flowchart showing operation of a system embodying the invention.

FIGS. 5 and 6 are illustrations of instruments embodying the invention, particularly illustrating their front panel user input and output interfaces.

### DETAILED DESCRIPTION

### Terminology

The term “specifications,” when applied to electronic instruments, generally refers to performance specifications. In the present patent application, the term will be used with that understanding as to its meaning. “Specification” and “performance specification” will be used synonymously. A performance specification for an instrument may be specified by the user, based on now the user intends to use the instrument. For clarification, a line of instruments may have a spectrum of varying performance specifications, which we might characterize as being of increasing capability. The user selects an instrument from this line, having specifications that meet the user's needs. Documentation on specifications for different types of instruments are generally provided in the product documentation for the instrument. Examples of performance specifications will be given below, in connection with an exemplary type of instrument, a power supply. While the present patent application uses this as an example, it will be understood that the spirit and scope of the invention as described and claimed herein includes such other types of instruments, with their respective documentation and performance specifications set forth therein.

Other terms, when applied to such electronic instruments, include “parameters” and “settings.” Such parameters, settings, etc., plus input data (for instance operating temperature, elapsed times since last calibration, etc.) may be used in the calculation of performance specifications.

### Configurable Instruments

Instruments, such as electronic instruments, are used in a wide variety of environments and applications. For instance, test or measurement instruments are employed in test or measurement systems employed in industries such as aerospace, defense, consumer electronics, computers and peripherals, communications, semiconductors, and automotive electronics.

In broad terms, we might say that such an instrument is a type of functional apparatus, having a functionality. In the discussion which follows, the terms “instrument” and “functional apparatus” will be used synonymously. It will be understood, however, that such use is to be construed broadly and without limitation as to what sort of instruments, devices, etc., the terms may cover.

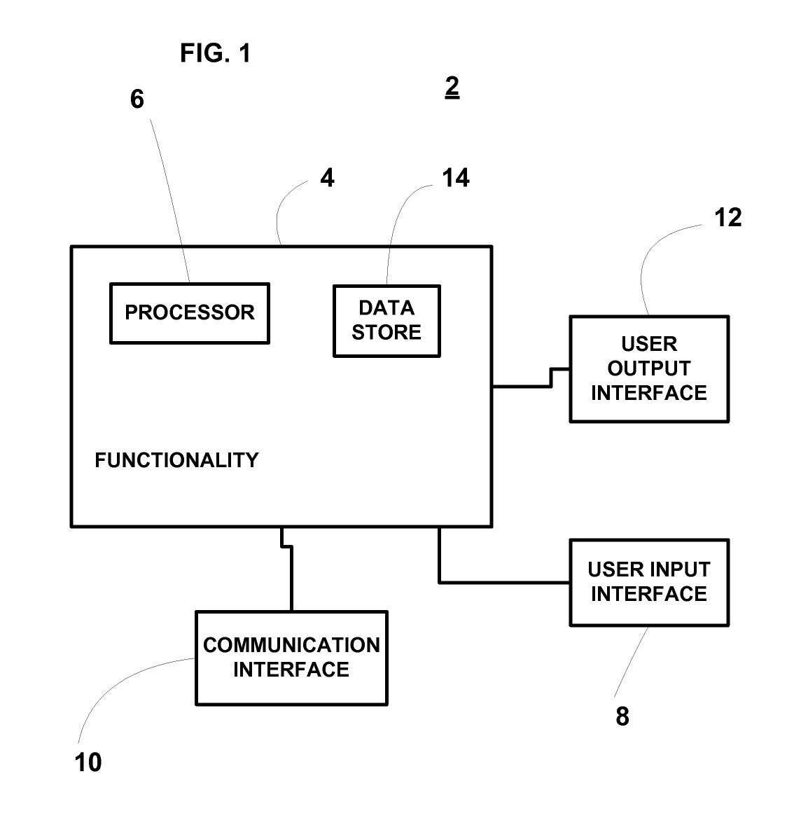

FIG. 1 is a schematic block diagram of such a functional apparatus 2. (As noted above, the term “instrument 2” will also be used as a synonym therefor.) Its functionality is shown schematically as a functionality 4. Many types of such instruments 2, for instance electronic instruments, will include a processor 6 and operating software (not separately shown) for performing the functionality 4 of the instrument 2.

The functionality 4 may be defined in terms of a set of capabilities, where the capabilities are specified in specifications. This specifications may be documented in a manual, data sheets, etc., that are provided to the user along with the functional apparatus 2 itself. The functionality 4 may include configurable specifications.

The functional apparatus may include a user input interface 8, through which the user enters input information pertaining to the performance specifications such as user settings, configurable parameters, etc., to configure the functional apparatus 2 to meet the user's needs. The user input interface 8 may include a keyboard or keypad, etc. Alternatively, the user input interface 8 could include a touch screen, a link to user peripherals such as a keyboard and mouse, an interface to the Internet, etc.

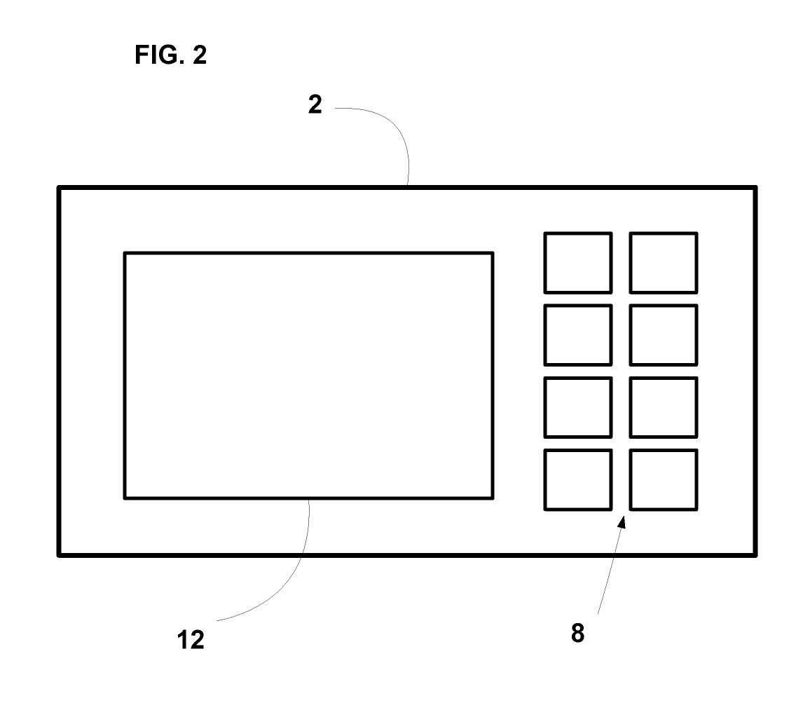

FIG. 2 is a simplified diagram of the functional apparatus 2 embodying the invention, showing the user input interface 8 as such a keypad.

Additionally, the functional apparatus 2 may include a communication interface 10. The input information may be entered through the communication interface 10, for instance from a memory store, from a remote device (not shown) or over the Internet. The communication interface 10 may also carry information, such as factory-specified specifications for the functional apparatus 2, from the functional apparatus to such remote device, memory store, internet, etc.

In an embodiment, there is also provided a user output interface 12, which may include a front panel, a display screen such as that shown in FIG. 2, an output signal arrangement such as an array or set of LEDs, alphanumeric LED arrays, or other coded signal lights, etc. Alternatively, the user output interface 12 could include a printer such as a small paper tape printer, etc. The instrument 2 may also provide an output through the communication interface 10.

When the functional apparatus 2 is configured, the specifications may be displayed or otherwise provided to the user, through the user output interface 12. The user output interface 12 enables the user to view the specifications. One or more configurable parameters, to be used in calculations of specifications, may also be displayed.

The user output interface 12 may be part of a more comprehensive user interface having both input and output capabilities. This enables the user to input information such as settings and configurable parameters. The user input can be manipulation of user input control apparatus, downloading over a communication line through the communication interface 10, selection from a menu or from previously used and stored specifications, etc.

Where calculations are necessary for determining aspects of the specifications, the user can input configurable parameters, one or more of which will be the operands of the calculations, and the instrument 2 then performs the calculations to arrive at the appropriate specifications. Alternatively, the user may input the desired performance specifications, and calculations are then “worked backwards” to derive any parameters, etc., that may be necessary in order to achieve the desired performance specifications. The calculations may be performed by the processor 6, employing appropriate software. The results of such calculations may be displayed on the front panel, or otherwise provided to the user through the user output interface 12.

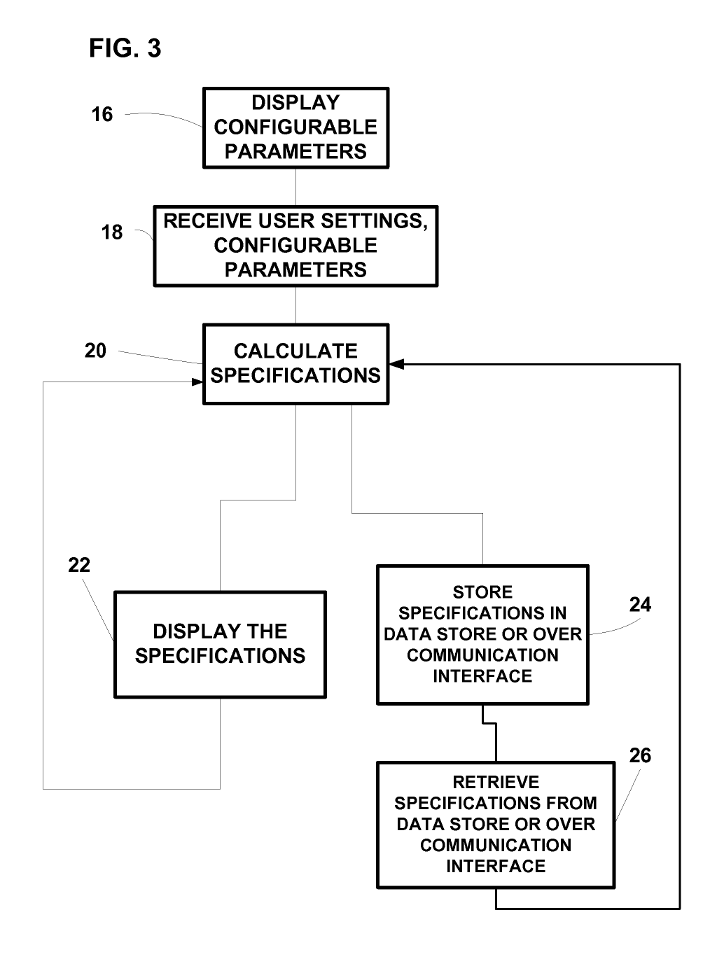

FIG. 3 is a flowchart showing operation of an instrument 2 embodying the invention. The instrument 2 displays (16) the configurable parameters on its user output interface 12. User parameters or settings are received (18), for instance by the user entering them through the user input interface 8, or through the communication interface 10. The instrument 2 then calculates (20) the specifications, and displays (22) the calculated specifications to configure itself for operation. Optionally, the instrument 2 may store (24) the calculated specifications, and then later retrieve (26) the stored specifications for display on the user output interface 12, or for re-configuring itself at a later time. The storage (24) and retrieval (26) are shown as a separate, parallel path from the display (22), but they may be done in other sequences, such as in series.

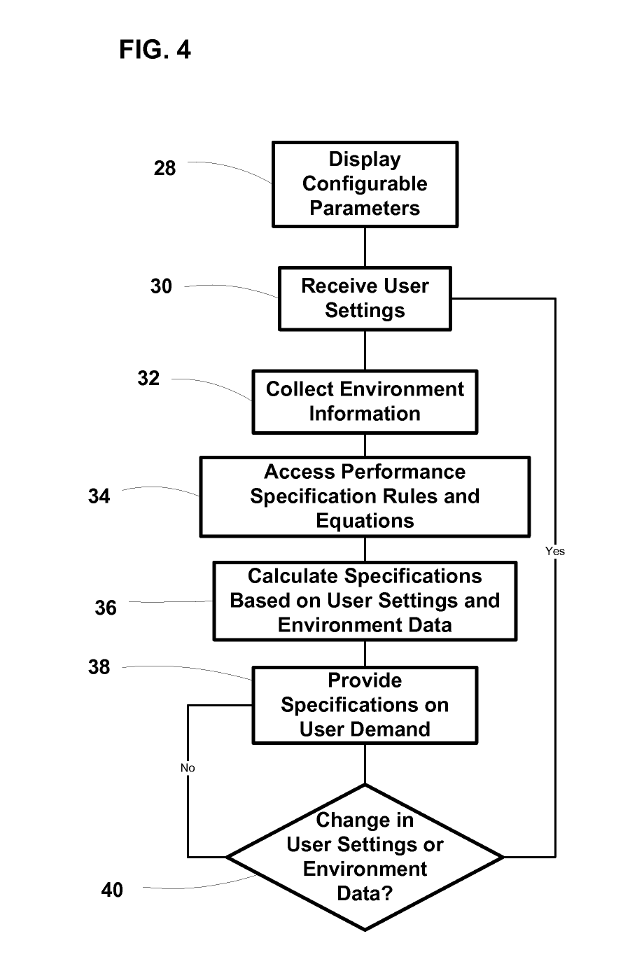

FIG. 4 is a flowchart showing a different operation of an instrument 2 embodying the invention. The instrument 2 displays (28) the user-selectable specifications on its user output interface 12. Selected configurations are received (30), for instance by the user entering them through the user input interface 8, or through the communication interface 10. These are similar to the activities (16) and (18) of FIG. 3.

In the embodiment of FIG. 4, the instrument 2 additionally collects environment information (32), potentially to use the collected environment information for use in calculating specifications. The instrument 2 additionally accesses (34) performance specification rules and equations, algorithms, etc., for instance from a specification memory store within the instrument 2's system memory (not shown) that is accessible by the processor 6.

The instrument 2 then calculates (36) the performance specifications, using the aforementioned user input and other information. In either the activity (20) of FIG. 3, or the activity (36) of FIG. 4, the specifications may be calculated by the processor 6 using programmed formulae, algorithms, etc. (not separately shown in FIG. 1).

The instrument 2 provides (38) the calculated specifications, for instance to the user output interface 12. Additionally, the instrument 2 may enter the calculated configurations, generally as shown in the activity (22) of FIG. 3.

The user, viewing the provided specifications, may input a change (40) in specifications through the user input interface 8. Also, input data such as environmental data may be received (40). If such events do not take place, the specifications previously calculated (36) may be provided (38) again on demand. If so, the specifications may be re-calculated, by again performing the activities (30) through (36).

### EXAMPLE

### A Power Supply

Just to name one example, power supplies are employed in many such systems. Many types of such test or measurement systems, often very complex, require one or more power sources. Where different power sources, for different voltages, require different amounts of power, some higher than others, the user may optimize costs and power consumption by configuring the instrument with performance specifications for allocating the power as needed.

When a user configures an instrument for the user's particular needs, many such specifications may be taken into account. Thus, the user who is configuring an instrument for his/her particular needs will need to refer to specifications of the instrument's capabilities. Complex data sheets and specifications tend to become more complicated and harder to comprehend by the average user. Sometimes many factors influence the accuracy of an instrument, and interpreting the specifications can become a daunting task. Customers may be reluctant or unable to characterize and specify instruments as thoroughly and precisely as their needs require. This may detract from the value and effectiveness that the instruments provide to the customer.

The discussion which follows will present embodiments of the present invention in connection with the N6700 MPS family of power supply instruments manufactured by Agilent Technologies, Inc., and described in the N6700 Product Overview document, published Jun. 15, 2007 and filed herewith. The N6700 Product Overview document is incorporated by reference and made a part of the present patent application. This, however, is without limitation as to other types of instruments which may embody the invention.

Let us consider, for instance, such a power supply instrument (hereinafter “power supply”) for a test and measurement system (hereinafter “T&M system” or “system”). The power supply may need to provide multiple power sources. Also, an instrument maker might provide a family of such instruments over a range of performance levels.

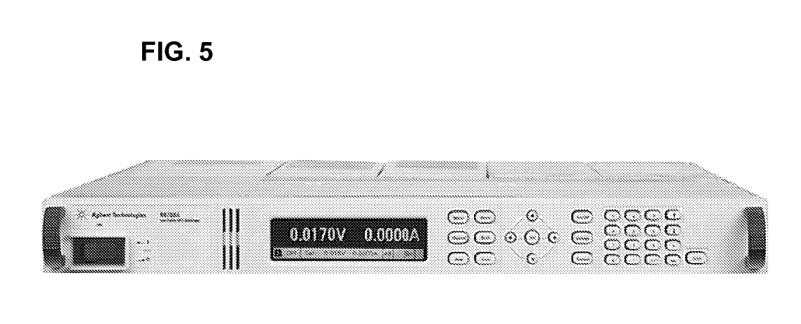

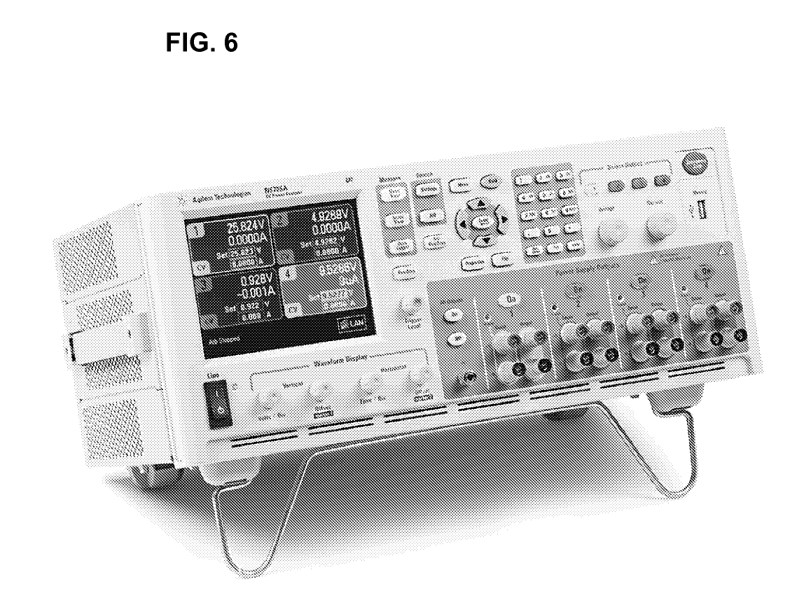

For instance, Agilent Technologies, Inc., provides a family of modular power supply instruments, designated by model numbers N6701, N6702 and N6705. FIGS. 5 and 6 illustrate such power supply instruments. These units are mainframes that accept various N67XX modules having different performance levels.

Each module performs to different specifications, which may be affected by real time information such as operating point, temperature, humidity, time since calibration. These specifications may, for instance, include the following:

DC Output Ratings, including voltage, power, and current. Additionally, for instance, current may be derated 1% per degree C. above 40 C.
Output Ripple and Noise (PARD), including CV peak-to-peak and CV rms.
Load effect (Regulation), including voltage, and current at specified ranges of voltage.
Source effect (regulation), including voltage and current.
Programming accuracy, including high-range and low-range voltages, high-range current, and low-range current over specified voltage ranges.
Measurement Accuracy, including high-range and low-range voltages, high-range current, and low-range current for specified ranges of voltages.
Load Transient Recovery Time, including voltage settling band and time.

The user selects an instrument from a product line of instruments with these specs in mind, choosing the instrument with the appropriate specifications to match his/her needs.

Users may find that one or more of the specifications for a given instrument are apt to be referred to more frequently than others. For instance, for an instrument such as the power supply with specifications described above, two commonly referred-to specifications might be the Programming and Measurement Accuracy specification. These two specifications are useful to help the user determine the uncertainty in the output of the power supply.

For example, consider the specifications for the N6751A module manufactured and sold by Agilent Technologies, Inc. If the power supply is programmed to output 50V, using the 0.06%+19 mV specification from the datasheet, it can be calculated that there is +−49 mV of uncertainty in the output (output can be as high as 50.049V and as low as 49.951V).

Likewise, similar calculations can be made for current programming and measurement, as well as for many other specifications.

An instrument embodying the invention may, for instance, display real time measurement of voltage and current. The display may provide a menu showing real time calculation of the specifications, based on the measurements and programmed voltage and current. An embodiment of the invention having a sufficiently large display may accommodate this feature, and also have a scope mode, where it displays traces of voltage and current versus time. The specification calculation feature can also be implemented in that mode by displaying a guard band showing the lower and upper bound traces around the measurement trace.

User-selectable settings and configuration parameters may include output voltage, output current, output voltage measurement range, output current measurement range, output power, and averaging window, among others that will be known and understood to persons skilled in the fields of test and measurement, and power supplies. For instance, consider the specification of measurement accuracy, listed above. Measurement accuracy may include high-range and low-range voltages, high-range current, and low-range current for specified ranges of voltages. The user might select, as a user setting or configurable parameter, the high range or the low range. Then, the calculation for the configuration of measurement accuracy is made, using the user-selected range (high or low), as an operand of the calculation. Referring again to FIG. 3, the user selected range is input (18), and the measurement accuracy is then calculated (20).

### Modular Architecture

The instrument 2 may accommodate modules (not shown) that can be connected and disconnected to a mainframe. For instance, there might be a family of interface-compatible modules that the user can easily swap in and out, to allow the user to configure the instrument 2 to best meet his/her needs. Each module may have a separate processor, and may communicate with a separate processor on-board the mainframe.

A system embodying the invention, and having such a modular architecture, may store the performance specification either in the mainframe or locally to the modules. When this data is combined with real time data such as operating point, temperature (readily measured and known by the unit), humidity, altitude (can be measured by the customer), the processor of the module can perform the needed computations, as discussed above, for instance the calculations of (36) of FIG. 4, and make the specifications resulting from the calculation available to the user based on real time information. The specifications can be displayed on the front panel, such as through menus. Also, the specifications may be communicated over the mainframe communication interface 10 to a data repository such as a logging PC, or for remote display, such as on the product webpage.

An instrument embodying the invention will relieve the user of the burden of calculating final performance specifications, because the calculations required are in the hands of the designers of the instrument, who are well qualified to perform the task. Using an instrument embodying the invention, the user can be sure that the instrument is indeed able to satisfy the user's needs. Providing the results on the front panel can boost user productivity, by eliminating the need for the user to take out the product documentation and calculate the specifications. By making the live specs available through the user output interface or over the communications bus, customers can also log and archive the specification, for later referral and validation.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A system comprising:
functional apparatus having a plurality of performance capabilities as per a specification;
a user output interface;
a processor for calculating the specification for achieving a desired performance of the functional apparatus; and
an output controller for providing the calculated specification on the user output interface.

2. A system as recited in claim 1, wherein at least one configurable parameter is an operand of the calculation of the specification.

3. A system as recited in claim 2, wherein the calculation of the specification includes, as operands, quantitative accuracy measurements for the at least one parameter.

4. A system as recited in claim 1, further comprising a data store for storing calculated specifications, wherein the processor stores the specification in the data store, and retrieves the specification from the data store for display on the user output interface.

5. A system as recited in claim 1, wherein the system includes an electronic instrument.

6. A system as recited in claim 5, wherein the electronic instrument includes a power supply module.

7. A system as recited in claim 1, further comprising a communication link interface.

8. A system as recited in claim 1, wherein the user output interface includes a user-visible front panel.

9. A system as recited in claim 1, further comprising at least one user-selectable and -interchangeable module.

10. A method for operating a system which includes functional apparatus having a plurality of performance capabilities as per a specification, the method comprising:
calculating the specification for achieving a desired performance of the functional apparatus
providing the calculated specification to the user through a user output interface; and
entering the calculated specification into the functional apparatus for setting the operation of the functional apparatus.

11. A method as recited in claim 10, wherein:
the specification includes configurable parameters for setting the operation of the functional apparatus; and
the calculating includes using at least one of the configurable parameter as an operand for the calculation of the specification.

12. A method as recited in claim 10, further comprising:
storing the calculated specifications; and
retrieving the stored specifications for one of display and entry into the system.
